(19) United States
(12) Patent Application Publication
(10) Pub. No.: US 2007/0046431 A1
(43) Pub. Date: Mar. 1, 2007

(54) System and method for combining RFID tag memory

(75) Inventors: Sayan Chakraborty, Niwot, CO (US); Sean T. Loving, Lafayette, CO (US)

Correspondence Address: LATHROP & GAGE LC, 4845 PEARL EAST CIRCLE, SUITE 300, BOULDER, CO, 80301, US

(73) Assignee: SkyeTek, Inc.

(21) Appl. No.: 11/387,422

(22) Filed: Mar. 23, 2006

Related U.S. Application Data
(63) Continuation-in-part of application No. 11/323,214, filed on Dec. 30, 2005.
(60) Provisional application No. 60/712,957, filed on Aug. 31, 2005.

(51) Int. Cl. H04Q 5/22

(52) U.S. Cl. 340/10.1; 340/10.51

(57) ABSTRACT

A system and method generate an extended memory RFID tag by reading data from a memory of a plurality of RFID tags, each including tag identification information stored thereon. The data is combined, in accordance with the tag identification information stored on at least one of the RFID tags, to generate the extended memory RFID tag. Sequencing indicia may be stored in memory in each of a plurality of RFID tags to allow the data to be combined, in accordance with the sequencing indicia.

### RELATED APPLICATIONS

This application claims priority to U.S. Patent Application Ser. No. 60/712,957, filed Aug. 31, 2005, entitled “RFID Systems And Methods.” This application is also a continuation-in-part of U.S. patent application Ser. No. 11/323,214 filed Dec. 30, 2005, entitled “System and Method for Implementing Virtual RFID Tags.” The disclosures of which are incorporated herein by reference.

### BACKGROUND

Radio Frequency Identification (RFID) is the use of radio frequencies to read information on a small device known as an RFID tag. There are several types of RFID tag, including: active RFID tags, which are battery powered devices that transmit a signal to a reader, and are typically readable over distances greater than one hundred feet; passive RFID tags, which are not battery powered but draw energy from electromagnetic waves from an RFID reader, and typically are readable over a distance of less than ten feet; and semi-passive RFID tags, which employ a battery to run the circuitry of a chip but rely on electromagnetic waves from a reader to power the transmitted signal.

Where an RFID tag includes an RFID tag chip, typically the RFID tag chip will include non-volatile memory that stores a unique identification number (UID). In certain RFID tags, the RFID tag chip also includes non-volatile re-writable memory that may be utilized to store information.

RFID tags have many physical formats, such as a microchip from 30 to 100 microns thick and from 0.1 to 1 mm across, joined to a minute metal antenna, or they can be in the form of deposited alloys 0.5 to 5 microns thick on a 20 micron polyester ribbon 1 mm across as used in some banknote security ribbons. Another form is the ‘Coil-on-Chip’ system, which is a 2.5 mm square integrated circuit with a coil mounted directly on the chip. The chip is a read-write chip with 108 bytes of re-writable memory.

RFID tags are interrogated and read using an RFID reader. In the case of passive RFID tags, the RFID reader supplies power to the RFID tag while reading the RFID tag.

FIG. 1 shows one exemplary prior art system 100 for reading RFID tag data. System 100 is shown with an RFID reader 102, an RFID tag 108 and an application 104. Application 104 interacts with RFID reader 102, via connection 106, to read from, and write to, RFID tag 108. RFID tag 108 has a finite memory capacity, which may not be increased without redesign or RFID tag 108.

FIG. 2 shows an exemplary memory map 200 of prior art RFID tag 108, FIG. 1. Memory map 200 is shown with a UID section 202, an application family identifier (AFI) section 204, a data storage format identifier (DSFID) section 206, security section 208 and a plurality of sections containing user blocks 210. AFI section 204 contains a plurality of bits that identify the application family to which RFID tag 108 belongs. DSFID 206 contains a plurality of bits that specifies the memory format (e.g., number of sections, type of memory, etc) of RFID tag 108. Security section 208 has a plurality of bits, each relating to a section of memory map 200, indicating which sections, if any, are write-protected. For example, a first bits within security section 208 may indicates if user block 210(1) is write-protected, a second bit of security section 208 may indicate if user block 210(2) is write protected, and so on.

Each section of memory map 200 may be read by RFID reader 102, and each section of memory map 200 that is not write protected may be written to by RFID reader 102.

Although RFID tags are available with many different memory sizes, they are typically limited to 2048 bits. It has not been previously possible to increase memory capacity of RFID tag 108 without developing and manufacturing a special RFID tag with a specific amount of additional memory and deploying it to the location of use. Therefore, the cost of increasing the memory capacity of RFID tag 108 is significant. A solution for increasing the size of usable memory corresponding to a particular RFID tag without developing and deploying a new RFID tag is therefore desired.

### SUMMARY OF THE INVENTION

In one embodiment, a method generates an extended memory RFID tag. Data is read from a memory of a plurality of RFID tags, each including tag identification information stored thereon. The data is combined, in accordance with the tag identification information stored on at least one of the RFID tags, to generate the extended memory RFID tag.

In another embodiment, a method generates an extended memory RFID tag. Sequencing indicia is stored in memory in each of a plurality of RFID tags. Data is read from the memory of a plurality of the RFID tags and combined, in accordance with the sequencing indicia stored on at least two of the RFID tags, to generate the extended memory RFID tag.

In another embodiment, a method generates an extended memory RFID tag by storing sequence numbers in memory in each of a plurality of RFID tags, reading data from the memory of a plurality of the RFID tags and combining, in sequence number order, the data stored on at least two of the RFID tags, to generate the extended memory RFID tag.

In another embodiment, an RFID tag data structure has a plurality of data segments, wherein the contents of each of the data segments are derived from a separate one of a plurality of RFID tags, at least one of which tags includes information for combining the data segments stored on the tags.

In another embodiment, an extended memory RFID tag has a plurality of data segments, each of which has been read from a corresponding RFID tag, wherein each of the data segments has been stored in a relative order in accordance with sequencing indicia associated therewith on a corresponding RFID tag.

### BRIEF DESCRIPTION OF THE FIGURES

FIG. 1 shows one prior art RFID system including an RFID tag reader, an RFID tag and an application.

FIG. 2 shows a memory map for the prior art RFID tag of FIG. 1.

FIG. 3 shows one exemplary Radio Frequency Identification (RFID) system illustrating a combiner for combining data from the memory of a plurality of RFID tags as a data structure.

FIG. 4 shows one exemplary embodiment of a combiner including a plurality of RFID readers and an application.

FIG. 5 shows a memory map, from which a data structure is constructed in one exemplary embodiment of the present system.

FIG. 6 shows one exemplary data structure assembled from the memory map of FIG. 5.

FIG. 7 shows a memory map of one exemplary embodiment of the data structure of FIG. 3, where N, the number of different RFID tags from which data will be combined, is four

FIG. 8 shows a memory map illustrating one exemplary embodiment of the data structure of FIG. 3, where N has a value of 4.

FIG. 9 shows a memory map of one exemplary embodiment of the data structure of FIG. 3 where N is four

FIG. 10 shows a memory map of one exemplary embodiment of the data structure of FIG. 3, where N is four, with four corresponding off-tag memory locations.

FIG. 11 shows one exemplary networked RFID reader system for combining RFID tag memory.

FIG. 12 shows one exemplary system for extending the memory of an RFID mega-tag.

FIG. 13 is a flowchart showing an exemplary method for combining RFID tag memory.

### DETAILED DESCRIPTION OF THE FIGURES

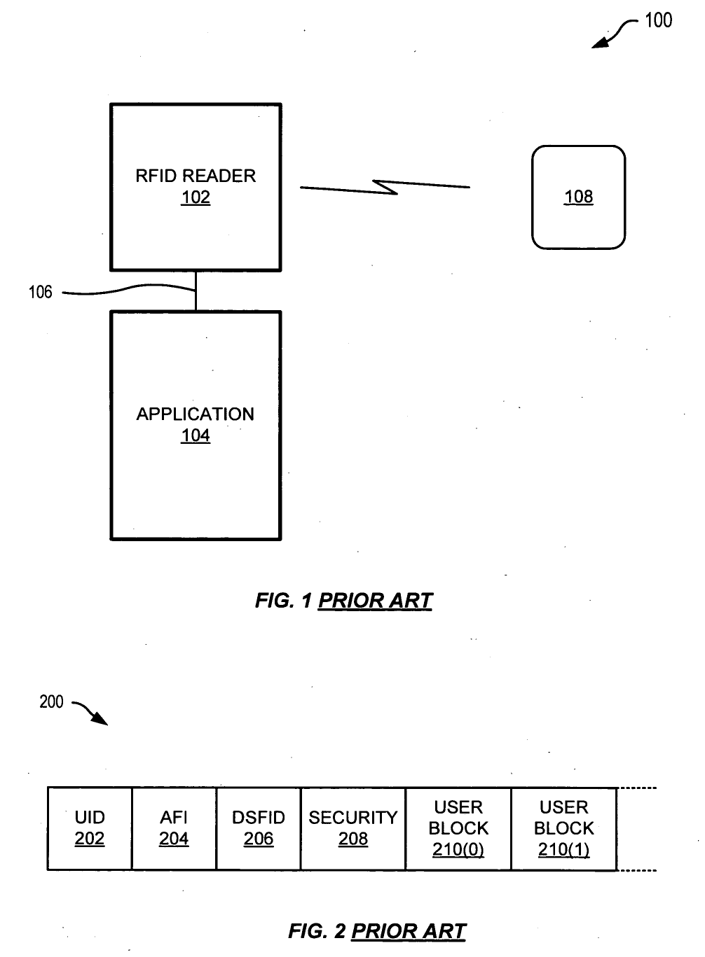

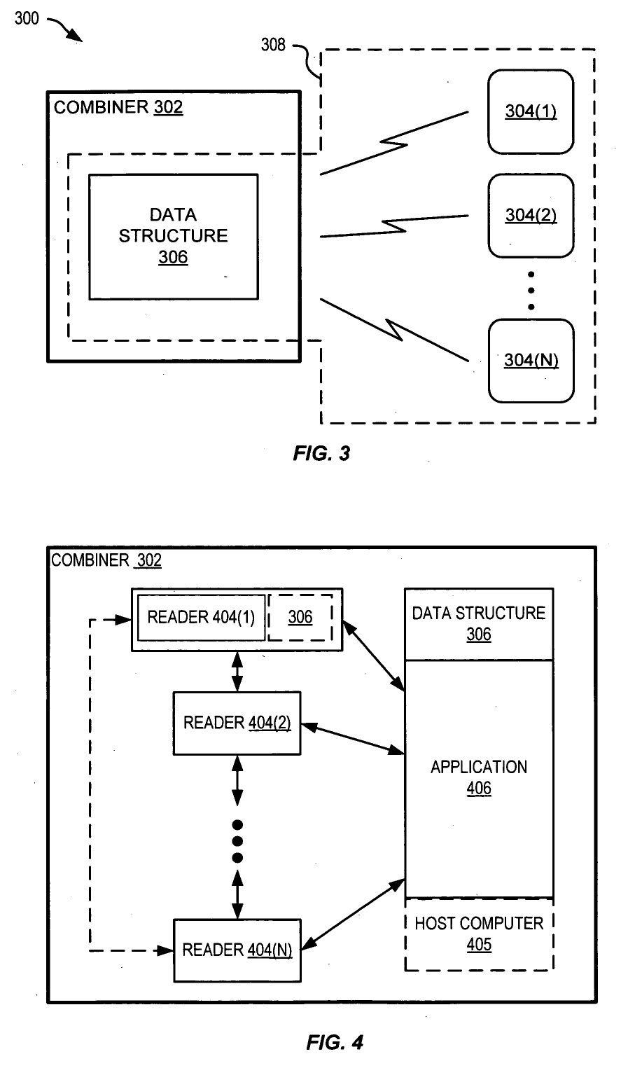

FIG. 3 shows one exemplary Radio Frequency Identification (RFID) system 300 illustrating a combiner 302 for combining data from the memory of RFID tags 304(1-N). Combiner 302 reads and combines certain data from memory of a plurality of RFID tags 304 to generate a data structure 306. Data structure 306 and RFID tags 304 may be considered in combination to form an RFID ‘mega-tag’ 308. Each of RFID tags 304 is a ‘standard’ component; that is, each of the tags 304 are RFID tags which are available from various manufacturers. For the present system 300 to create a mega-tag 308, the RFID tags 304 used by the system 300 are not required to have identical memory capacities, nor does each tag 304 need to be of the same type or model number. Each RFID tag 304 may thus represent arbitrary RFID tag 108 of FIG. 1.

Data structure 306 derived from RFID tags 304, together with the tags themselves (or at least with certain data stored in the tags) form an RFID mega-tag 308, also referred to herein as an extended memory RFID tag 304.

FIG. 4 shows one exemplary embodiment of a combiner 302 including a plurality of RFID readers 404(1-N) and an application 406. RFID readers 404 and application 406 cooperate to combine data stored in a plurality of RFID tags (e.g., RFID tags 304, FIG. 3) to generate data structure 306. Data structure 306 may, for example, be located in any one or RFID readers 404 and/or application 406. Application 406 may be any type of RFID software or firmware application. Application 406 may run (i.e., may be executed) in one or more of the readers 404(1-N), and/or in a host computer physically separate from readers 404. It is envisioned that application 406 may be executed in a distributed manner by cooperation between programs running in different readers 404(1-N), and, optionally, with the aid or supervision of a program running on a host computer 405.

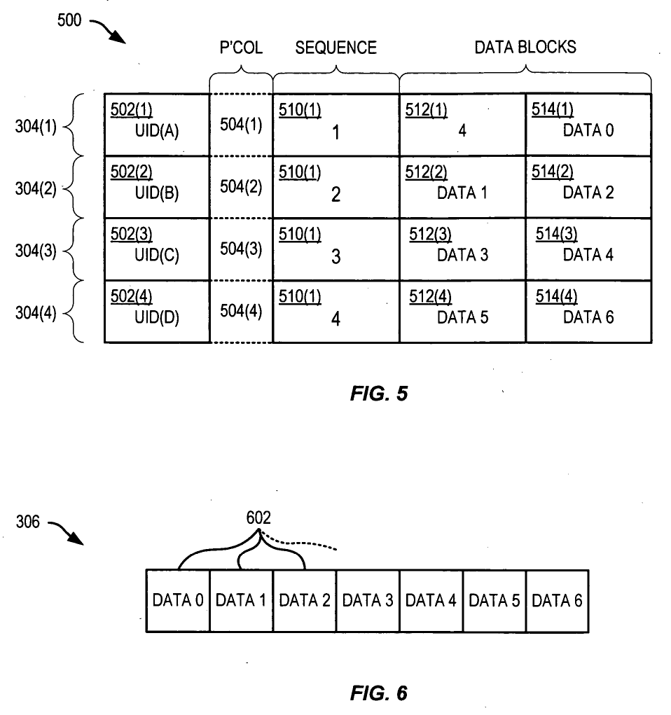

FIG. 5 shows a memory map 500, from which data structure 306 is constructed in one exemplary embodiment of the present system. In this embodiment, data from four RFID tags 304(1-4) is combined to generate data structure 306. For example, RFID tag 304(1) is shown with a unique identification number (UID) section 502(1), a protocol section 504(1) and three user blocks 510(1), 512(1) and 514(1); RFID tag chip 304(2) is shown with a UID section 502(2), a protocol section 504(2) and three user blocks 510(2), 512(2) and 514(2); RFID tag chip 304(3) is shown with a UID section 502(3), a protocol section 504(3) and three user blocks 510(3), 512(3) and 514(3); and RFID tag chip 304(4) is shown with a RFID section 502(4), a protocol section 504(4) and three user blocks 510(4), 512(4) and 514(4). Protocol sections 504 may each contain an application family identifier (AFI) section, a data storage format identifier (DSFID) section and a security section. UID section 502 thus represents tag identification information that uniquely identifies each RFID tag.

In the present exemplary embodiment, the first user block 510 of each RFID tag 304 memory is utilized to indicate a sequence or order for the RFID tags of RFID mega-tag 308. For example, section 510(1) of RFID tag 304(1) indicates that RFID tag 304(1) contains the first set of data to be stored within data structure 306. Similarly, sections 510 of RFID tags 304(2), 304(3) and 304(4) have sequence numbers 2, 3 and 4, respectively. The second user block 512(1) of the first RFID tag 304(1) contains a count (e.g., N) of the number of RFID tags 304 having (at least some of) the data contained therein to be stored within data structure 306. Thus, in the example of FIG. 5, user block 512(1) contains the value “4”, indicating that and data is to be read from four different RFID tags 304(1-N). Thus, data is read from user block 514(1) of RFID tag 304(1), as well as from user blocks 512 and 514 of RFID tags 304(2), 304(3) and 304(4) in sequence number order. Upon reading each RFID tag 304(1), 304(2), 304(3) and 304(4), combiner 302 may, for example, assemble data structure 306 such as shown in FIG. 6. Data structure 306 is generated by sequentially combining a plurality of segments 602, each formed of at least part of the data in each of RFID tags 304(1), 304(2), 304(3) and 304(4), based upon sequence numbers of user blocks 510 of each RFID tag 304. Data structure 306 may also be referred to as an RFID tag data structure.

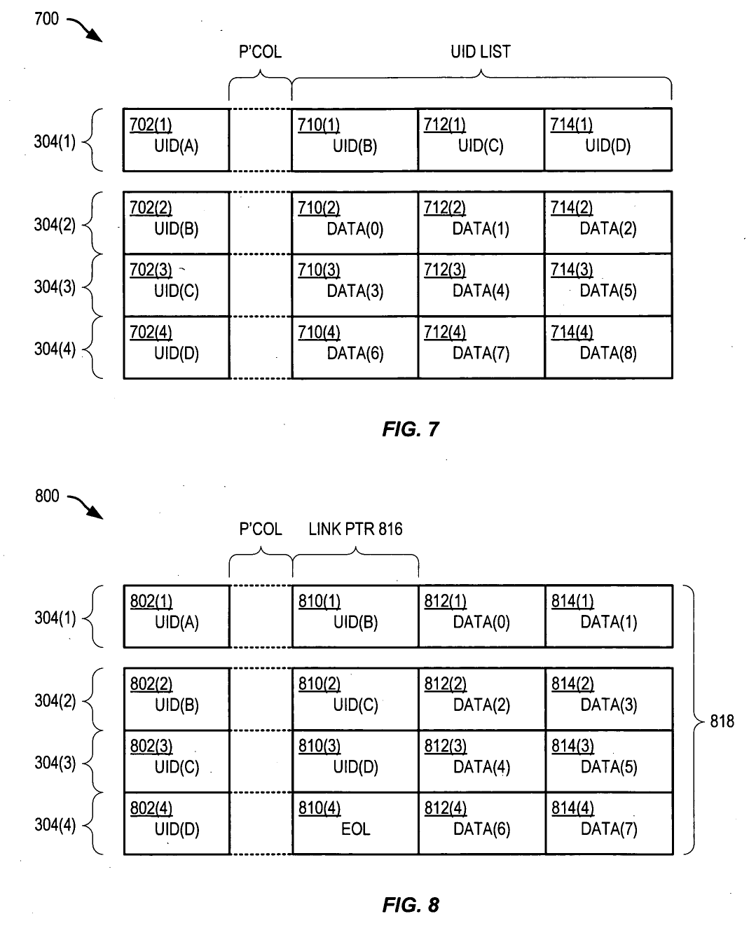

FIG. 7 shows a memory map 700 of one exemplary embodiment of data structure 306, where N, the number of different RFID tags from which data will be combined, is four. As shown in memory map 700, RFID tag 304(1) is a ‘master’ tag containing UIDs of other grouped RFID tags 304(2-4). In particular, RFID tag 304(1) stores the UID of other RFID tags belonging to RFID mega-tag 308, and may imply ordering where ordering is required. For example, user block 710(1) of RFID tag 304(1) contains UID(B) of RFID tag 304(2), user block 712(1) contains UID(C) of RFID tag 304(3) and user block 714(1) contains UID(D) of RFID tag 304(4). RFID tag 304(1) thus indicates that RFID tags identified as UID(B), UID(C) and UID(D) form at least part of memory of RFID mega-tag 308, and if necessary, should be processed (e.g., combined) in the given order, such as where the data stored within each RFID tag 304(2-4) is sequential in nature, shown as DATA(0-8). Where data stored within RFID mega-tag 308 is not sequential (e.g., where each RFID tag 304(2-4) contains individual data items), the ordering of RFID tags 304(2-4) may be unnecessary, or determined by a different sequencing mechanism.

FIG. 8 shows a memory map 800 illustrating one exemplary embodiment of data structure 306, where N has a value of 4, and thus data from four tags is to be combined. As shown in memory map 800, RFID tag 304(1) is a first RFID tag in a tag chain 818 that includes RFID tags 304(1-4). In particular, each user block 810 form a link pointer 816 to identify a next RFID tag of tag chain 818. User block 810(1) of RFID tag 304(1) identifies RFID tag 304(2) as the next RFID tag in tag chain 818. Remaining user blocks 812(1) and 814(1) of RFID tag 304(1) may be used to store data, shown as data(0) and data(1), respectively. User block 810(2) of RFID tag 304(2) identifies RFID tag 304(3) as the next RFID tag in tag chain 818. User block 810(3) of RFID tag 304(3) identifies RFID tag 304(4) as the next RFID tag in tag chain 818. Remaining user blocks 812(3) and 814(3) of RFID tag 304(3) may be used to store data, shown as data(4) and data(5), respectively. In the present example, user block 810(4) of RFID tag 304(4) has an end-of-link value that indicates that RFID tag 304(4) is the last RFID tag in tag chain 818. Remaining user blocks 812(4) and 814(4) of RFID tag 304(4) may be used to store data, shown as data(6) and data(7), respectively. An additional link pointer, or link pointer 816, may be utilized to provide a reverse ordering of RFID tags within tag chain 818 without departing from the scope hereof.

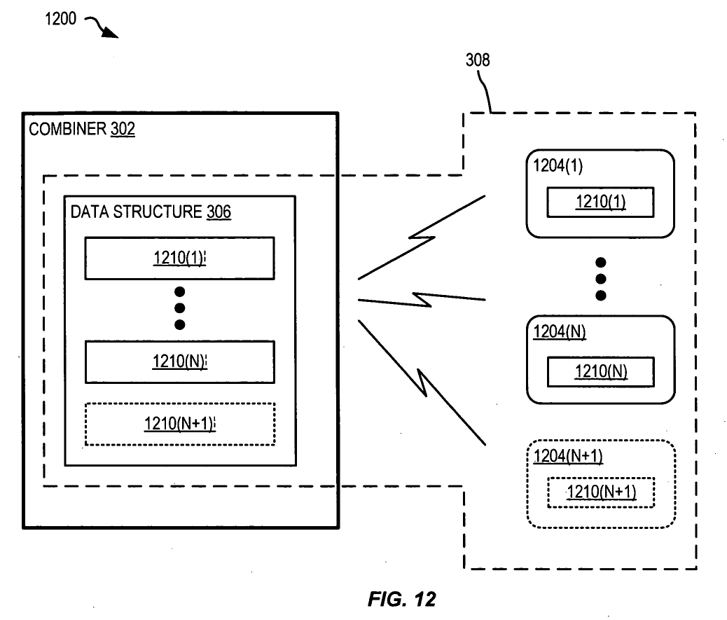

In another embodiment, RFID mega-tag 308 includes a fixed number of RFID tags (e.g., RFID tags 304(1-4)) that have sequential UIDs. Thus, memory capacity of the RFID mega-tag is predetermined, and combiner 302 may determine RFID tag ordering (i.e., the ordering of the data read from each RFID tag comprising mega-tag 308) without additional information. As shown in FIG. 12 (described below), memory capacity may be extended by inserting or appending one or more additional RFID tags.

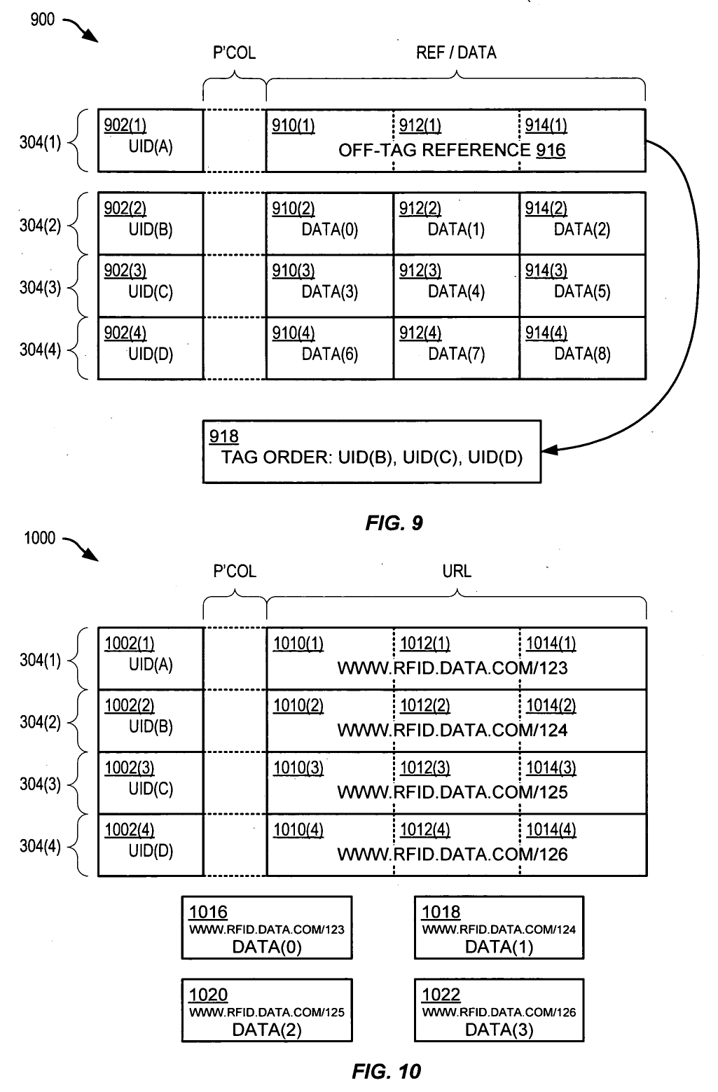

FIG. 9 shows a memory map 900 of one exemplary embodiment of data structure 306 where N (the number of different RFID tags from which data will be combined) is four. User blocks 910(1), 912(1) and 914(1) of RFID tag 304(1) are used to store an off-tag reference 916 to an off-tag information store 918. Off-tag reference 916 indicates the location of off-tag information store 918, and may take the form of an index number, a pointer, an Internet address, or other indicia. Off-tag information store 918 may, for example, be located within an RFID reader or within a remotely located database. In FIG. 9, information store 918 is shown storing UIDs (B, C and D) of RFID tags 304(2-4), which define the location and order of data(0-8). Specifically, user blocks 910(2), 912(2) and 914(2) of RFID tag 304(2) store data(0), data(1) and data(2), respectively; user blocks 910(3), 912(3) and 914(3) of RFID tag 304(3) store data(3), data(4) and data(5), respectively; and user blocks 910(4), 912(4) and 914(4) of RFID tag 304(4) store data(6), data(7) and data(8), respectively.

Sequence section 510, FIG. 5, UID list 710, FIG. 7, link pointer 816, FIG. 8, and off-tag reference 916, FIG. 9, may each be referred to as sequencing indicia.

FIG. 10 shows a memory map 1000 of one exemplary embodiment of data structure 306, where N is four, with four corresponding off-tag memory locations 1016, 1018, 1020 and 1022. In the present example, memory locations 1016, 1018, 1020 and 1022 are shown as web pages on the Internet identified by Uniform Resource Locators (URLs). Thus, in the embodiment of FIG. 10, user blocks 1010(1), 1012(1) and 1014(1) of RFID tag 304(1) are used to store a URL (“www.RFID.DATA.COM/123”) that identifies ‘off-tag’ memory location 1016, which stores information, shown as data(0), relating to RFID tag 304(1). User blocks 1010(2), 1012(2) and 1014(2) of RFID tag 304(2) are shown storing a URL (“www.RFID.DATA.COM/124”) that identifies off-tag memory location 1018, which stores information, shown as data(1), relating to RFID tag 304(2). User blocks 1010(3), 1012(3) and 1014(3) of RFID tag 304(3) are shown storing a URL (“www.RFID.DATA.COM/125”) that identifies off-tag memory location 1020, which stores information, shown as data(2), relating to RFID tag 304(3). User blocks 1010(4), 1012(4) and 1014(4) of RFID tag 304(4) are shown storing a URL (“www.RFID.DATA.COM/126”) that identifies off-tag memory location 1022, which stores information, shown as data(3), relating to RFID tag 304(4). In one embodiment, all of the data of interest for a number of tags may be stored on one web page and specific blocks of data on that web page may be referenced by using a URL and a delimiter. For example, two different blocks of data on web page “www.rfid.data.com/100” could be identified by the URLs “www.rfid.data.com/100#123” and “www.rfid.data.com/100#124” (where the delimiter is “#”).

In one example, each off-tag information storage locations 1016, 1018, 1020 and 1022 identified by RFID tags 304 provide different types of information for RFID mega-tag 308. Additional or fewer RFID tags may be included within RFID mega-tag 308 without departing from the scope hereof.

As shown in the embodiments of FIGS. 9 and 10, the potential amount of information that may be stored ‘off-tag’ (e.g., within locations 918, 1016, 1018, 1020 and 1022 in a computer database system) is significantly greater than the amount of information that is practical to store on a number of RFID tags 304, since RFID tag memory capacity is not only relatively limited, but also relatively expensive, in comparison to disk drive storage. Therefore, in one embodiment, only one RFID tag is required to reference an ‘off-tag’ location (e.g., location 1016) that can contain as much data associated with the RFID tag as desired.

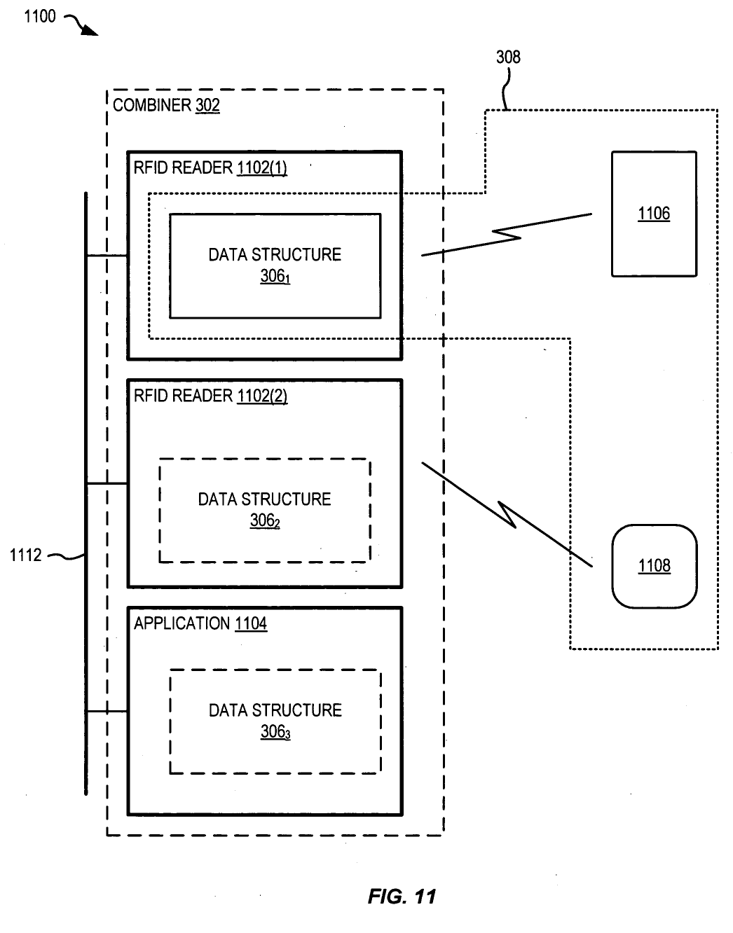

FIG. 11 shows one exemplary networked RFID reader system 1100 for combining RFID tag memory in accordance with the present method. System 1100 is shown with two RFID readers 1102(1) and 1102(2) and an application 1104 that communicate over network 1112. Network 1112 may be, for example, an Ethernet network, a wireless network, a multi-drop serial network, or any other networking mechanism for allowing multiple RFID readers 1102 to communicate with one another. Application 1104 may run, for example, on a server or host that is remote from RFID readers 1102. RFID reader 1102 and application 1104 operate as a combiner 302. FIG. 11 also shows two RFID tags 1106 and 1108 that are located outside the range of a single RFID reader. In the present example, RFID tag 1106 is within reading range of (‘in-field’ relative to) RFID reader 1102(1), but not in-field relative to RFID reader 1102(2), and RFID tag 1108 is in-field relative to RFID reader 1102(2) but not in-field relative to RFID reader 1102(1).

In an example of operation, RFID reader 1102(1) reads RFID tag 1106 and RFID reader 1102(2) reads RFID tag 1108. Assuming that RFID tag 1106 represents a first RFID tag of RFID mega-tag 308, RFID reader 1102(1) reads RFID tag 1106 to create a data structure 306, in which to store data for RFID mega-tag 308. In the present example, upon reading certain data of RFID tag 1108, RFID reader 1102(2) sends the data to RFID reader 1102(1), which combines the data into data structure 306₁. For example, RFID reader 1102(1) interacts with RFID reader 1102(2) to obtain data from RFID tag 1108.

In another example of operation, assuming that RFID tag 1108 is a first RFID tag of RFID mega-tag 308, RFID reader 1102(2) creates a data structure 306₂ by combining at least part of data read from RFID tag 1108 and at least part of data read from RFID tag 1106 that is sent to RFID reader 1102(2) by RFID reader 1102(1).

In another example of operation, RFID reader 1002(1) reads RFID tag 1004(1) and RFID reader 1002(2) reads RFID tag 1004(2). RFID reader 1102(1) sends data read from RFID tag 1106 to application 1104 and RFID reader 1102(2) sends data read from RFID tag 1108 to application 1104. Application 1104 then creates data structure 306₃ in which is stored data for RFID mega-tag 308 by combining at least part of data read from RFID tag 1106 and at least part of data read from RFID tag 1108.

FIG. 12 shows one exemplary system 1200 for extending the memory of an RFID mega-tag 308. Initially, RFID mega-tag 308 has ‘N’ RFID tags 1204(1)-1204(N) associated therewith, each including data blocks 1210(1)-1210(N), respectively. Combiner 302 operates to combine memory of RFID tags 1204(1)-1204(N) and generate data structure 306, shown with data segments 1210(1)^{♦}-1210(N)^{♦}, each of which represents at least part of combined data 1210(1)-1210(N). To increase the memory capacity of RFID mega-tag 308, data from an additional RFID tag 1204(N+1) is added to RFID mega-tag 308. RFID tag 1204(N+1) includes data block 1210(N+1) and combiner 302 may increase the size of data structure 306 to include data segment 1210(N+1)^{♦} which represents at least part of combined data 1210(N+1).

In one example, RFID tags 1204 of REID mega-tag 308 may be applied to a vessel containing a substance for processing. At each processing stage, an additional RFID tag (e.g., RFID tag 1204(N+1)) is affixed to the vessel, thereby increasing memory of RFID mega-tag 308 to accommodate processing information.

In another example, RFID tags 1204 of RFID mega-tag 308 may be applied to a machine (e.g., a tool within a workshop) that requires periodic maintenance. As maintenance is performed on the machine, at least one additional RFID tag (e.g., RFID tag 1204(N+1)) may be applied to the machine to increase memory of RFID mega-tag 308 to allow detail of the maintenance process to be stored within RFID mega-tag 308.

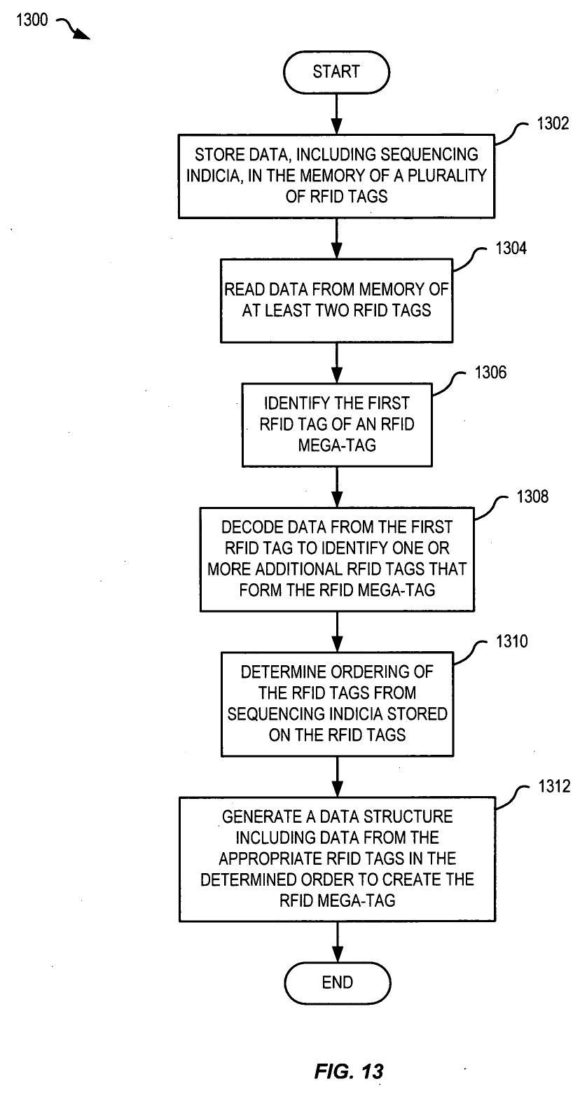

FIG. 13 is a flowchart showing an exemplary method 1300 for combining RFID tag memory. In step 1302, data is stored, including sequencing indicia, in the memory of a plurality of RFID tags 304. In step 1304, data is read from the memory of at least two RFID tags 304. In step 1306, the first RFID tag of an RFID mega-tag is read. In step 1308, data is decoded from the first RFID tag 304(1) to identify one or more additional RFID tags that are to be included in the RFID mega-tag. In step 1310, the ordering of the RFID tags comprising mega-tag 308 is determined from sequencing indicia stored on the tags. In step 1312, a data structure is generated by including data from the appropriate RFID tags in the determined order to create the RFID mega-tag 308.

Steps 1302-1312 may be reordered and certain ones of steps 1302-1312 may be omitted without departing from the scope of the present method. For example, where ordering of data stored within the RFID tags of the RFID mega-tag is not important, step 1310 may be omitted; where identification and ordering of the RFID tags of the RFID mega-tag is based upon their UIDs, steps 1308 and 1310 may be omitted.

Error Recovery and Redundancy

In another embodiment, an RFID mega-tag 308 includes a plurality of RFID tags 304 that operate to improve reliability of writing and reading data from and to the RFID mega-tag. Memory in the plurality of RFID tags may be organized to provide error recovery and redundancy such that if any one (or more, depending upon the redundancy scheme) RFID tag fails, the data on that tag can be recovered. Thus, the RFID mega-tag may be employed to provide increased data security relative to single RFID tags.

In one example, part of the memory in each of a plurality of RFID tags 304(1), 304(2), 304(3) and 304(4) of RFID mega-tag 308, FIG. 3, is utilized to provide redundancy and error correction for RFID mega-tag 308. Combiner 302 then performs error correction and recovery of data read from RFID mega-tag 308. Thus, RFID mega-tag 308 may appear to application 406, FIG. 4, as a conventional RFID tag with high reliability. Writing of error correction information and redundant data is also handled by combiner 302.

Security Application

In another embodiment, keying data may be distributed across a plurality of RFID tags of an RFID mega-tag, thereby requiring that each RFID tag be present (and readable) for the key to be operable. A variant of this method stores identity data on each tag (e.g. time of day) during encryption and then utilizes this identity data when decrypting as part of an Identity Based Encryption system (IBE). These concepts can be used with only one tag as well as with multiple tags.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for generating an extended memory RFID tag comprising:
reading data from memory of a plurality of RFID tags, each including tag identification information stored thereon; and
combining the data, in accordance with the tag identification information stored on at least one of the RFID tags, to generate the extended memory RFID tag.

2. The method of claim 1, further comprising identifying a first RFID tag of the plurality of RFID tags, using the tag identification information.

3. The method of claim 2, further comprising decoding the data in the first RFID tag to identify one or more other RFID tags of the plurality of RFID tags.

4. The method of claim 2, further comprising determining an ordering of the RFID tags based upon the tag identification information stored in the first RFID tag.

5. The method of claim 1, further comprising determining an ordering of the RFID tags based upon the tag identification information stored separately in each of the RFID tags from which the data is combined.

6. A method for generating an extended memory RFID tag comprising:
storing sequencing indicia in memory in each of a plurality of RFID tags;
reading data from memory of a plurality of the RFID tags; and
combining the data, in accordance with the sequencing indicia stored on at least two of the RFID tags, to generate the extended memory RFID tag.

7. The method of claim 6, wherein the sequencing indicia comprises a sequence number indicating the order in which the data is combined to generate the extended memory RFID tag.

8. The method of claim 6, wherein the sequencing indicia comprises an off-tag reference.

9. The method of claim 6, wherein the sequencing indicia comprises a link pointer.

10. The method of claim 6, wherein the sequencing indicia comprises a URL.

11. The method of claim 6, further comprising identifying a first RFID tag of the plurality of RFID tags, using the sequencing indicia.

12. The method of claim 11, further comprising decoding the data in the first RFID tag to identify one or more other RFID tags of the plurality of RFID tags.

13. The method of claim 11, further comprising determining an ordering of the RFID tags based upon the sequencing indicia stored in the first RFID tag.

14. The method of claim 6, further comprising determining an ordering of the data in the RFID tags based upon the sequencing indicia stored separately in each of the RFID tags from which the data is combined.

15. A method for generating an extended memory RFID tag comprising:
storing a sequence number in memory in each of a plurality of RFID tags;
reading data from the memory of a plurality of the RFID tags; and
combining, in sequence number order, the data stored on at least two of the RFID tags, to generate the extended memory RFID tag.

16. The method of claim 15, further comprising identifying a first RFID tag of the plurality of RFID tags by reference to the sequence number stored thereon.

17. The method of claim 16, further comprising decoding the data in the first RFID tag to identify one or more other RFID tags of the plurality of RFID tags.

18. The method of claim 16, further comprising determining an ordering of the RFID tags based upon the sequence numbers stored separately in each of the RFID tags from which the data is combined.

19. An RFID tag data structure comprising a plurality of data segments, wherein the contents of each of the data segments are derived from a separate one of a plurality of RFID tags, at least one of which tags includes information for combining the data segments stored on the tags.

20. An extended memory RFID tag comprising a plurality of data segments, each of which has been read from a corresponding RFID tag, wherein each of the data segments has been stored in a relative order in accordance with sequencing indicia associated therewith on the corresponding RFID tag.

21. The extended memory RFID tag of claim 20, wherein the number of data segments to be combined to generate the extended memory RFID tag is determined from information associated with at least one of the data segments on the corresponding RFID tag.
